(19) United States
(12) Patent Application Publication
(10) Pub. No.: US 2004/0066536 A1
(43) Pub. Date: Apr. 8, 2004

(54) Data control apparatus, and printing method and system

(76) Inventors: Kouichi Takamine, Hyogo (JP); Atsushi Hirose, Berkshire (GB)

Correspondence Address: MCDERMOTT WILL & EMERY, 600 13TH STREET, N.W., WASHINGTON, DC, 20005-3096, US

(21) Appl. No.: 10/637,010

(22) Filed: Aug. 8, 2003

(30) Foreign Application Priority Data
Aug. 8, 2002 (JP) 2002-230690

(51) Int. Cl. G06F 15/00; G06F 13/00

(52) U.S. Cl. 358/1.15; 358/1.13

(57) ABSTRACT

A data-control apparatus and data-printing method and system that automatically switch the output destination or output settings according to the type of contents. A rule-setting unit stores selection data for specifying the method of outputting the contents, and output methods corresponding to that selection data as rule data, and an output-selection unit selects the output method for the contents based on the selection data read from the contents and the rule data stored by the rule-setting unit.

### BACKGROUND OF THE INVENTION

1. Field of the Invention

This invention relates to a data-control apparatus that selectively outputs data such as text or images to a printing apparatus that is connected to a network, and to a printing method and system that uses this data-control apparatus.

2. Description of the Related Art

In recent years, with the development of networking technology such as the Internet, and broadband communication, it has become possible to not only to receive various kinds of digital contents via a network at the office, but also at home or in a mobile environment. These digital contents include data such as text or detailed images such as photos alone or in combinations.

Under the above conditions, any kinds of printers have been developed for home use according to the purpose of use. In other words, currently there are printers that are connected to personal computers, and there are so-called non-PC printers that will become more popular in the future. This non-PC printer is a printer that is connected to a television or STB (set-top box) and outputs specified contents that correspond to printing services that are provided for the television or STB.

These kinds of printers are divided into printers that are used for printing contents that include detailed images such as photographs, in which case the printing speed becomes somewhat slow and printing is performed in a detailed printing mode (photo-type printer), and printers that print data such as text, in which case the text is printed at high speed and such that it is easy to read (information-type printer). In other words, depending on the characteristics of the digital contents handled, a photo-type printer is used for a non-PC printer that is connected to a television or STB, and depending on the purpose of the personal computer, a information-type printer or photo-type printer is used for a PC printer that is connected to a personal computer. More particularly, an ink-jet printer or the like is suitable for use as a photo-type printer, and a laser printer or dot-impact printer is suitable for an information-type printer.

Conventionally, the user changed the setting of the printer driver for the personal computer to correspond to detailed images such as photos or data such as text in order to obtain the desired printing performance, or switched the output printer used.

However, in the case of printing text or the like with the photo-type printer, the performance obtained, from the aspect of printing quality and speed, is not as suitable as in the case of printing text or the like with the information-type printer. On the other hand, in the case of printing photos with the information-type printer, the printer often does not meet the needs for the image quality of the photo, and in most cases the printed material does not meet with satisfaction.

Moreover, in the case of using one printer, for example, using the photo-type printer, it is possible for the user to change the type of contents to be output (output setting) by changing the setting of the printer driver. However, in the case as well, when printing text or the like with the photo-type printer, it is still not possible to obtain the desired performance from the aspect of printing quality and speed. Also, in this case, the user must intervene in order to change the printer settings.

Particularly in the case of a non-PC printer, since the printer is not connected to a personal computer, it is difficult to perform detailed settings, and the problem of the need for the user to intervene remarkably stands out. Therefore, in the case of a non-PC printer, construction that does away with complicated and detailed settings by the user is particularly desirable.

As photographic devices that provide images such as photos, there are digital still cameras, digital video cameras, IP (Internet Protocol) cameras, etc., however, in the case of receiving and printing the images from these devices as well, it is feasible that the output printer would be switched depending on the image quality. In this case as well, it is desirable that the output settings for the contents be switched without the user having to perform complicated settings.

Moreover, in the case of receiving data by electronic mail and printing that data, it is desirable that the output settings for the contents be switched without the user having to perform complicated settings.

In this way, the conventional output process was a so-called ‘output-apparatus-priority’ type output process in which the user intervened by changing the settings of the output apparatus connected to a personal computer in order to properly output various kinds of contents.

### SUMMARY OF THE INVENTION

The object of this invention is to make possible a so-called ‘content-priority’ type of output process that selects the optimum destination output apparatus according to the type of contents received, or automatically switches the settings of the output apparatus.

In other words, taking the aforementioned problems into consideration, the object of this invention is to provide a data-control apparatus and data-printing method and system that automatically selects the output destination or switches the output settings according to the type of contents.

This invention applies the following means for accomplishing the aforementioned objective. In other words, it is presumed that this invention is a data-control apparatus that controls sending and receiving contents among a plurality of devices connected by a network.

Here, a rule-setting unit stores selection data for specifying the output method of the contents and the output method corresponding to that selection data as ‘rule’ data; and an output-selection unit selects the output method for the contents based on selection data read from the contents and the rule data stored by the rule-setting unit.

Also, when there is no selection data in the contents corresponding to the rule information, the output-selection unit may be constructed such that it obtains data from the transmission-source terminal that acquired the contents that can be used as selection data.

Moreover, the output-selection unit may further comprise a data-addition unit that determines the selection data based on at least one kind of data from among the acquisition state of the contents, the type of contents, and data obtained from the transmission-source terminal, and adds that selection data to the contents.

Furthermore, when it is not possible for the output-selection unit to select an output method that corresponds to the selection data, it is possible to display that fact on a specified display unit, or even to further display a substitute output method. Here, the specified display unit could be a display unit that is directly connected to the data-control apparatus, or could, for example, be a device that is connected to the data-control apparatus via a network. Concretely, the display unit such as a digital television, mobile terminals, personal computers or the like is enumerated.

The output method can be a method of specifying the terminal of the output destination, or specifying the output mode.

Moreover, the selection data can comprise: the resolution data or the number of pixels of the contents, output-destination data of where the contents will be output, photographic-mode data, which is data related to the photographic mode, size when outputting the contents, transmission-source data of the contents, etc.

Furthermore, it is also possible to have construction comprising: a receiving unit that receives electronic mail containing the aforementioned selection data and contents-acquisition-destination data, which is the address of the acquisition destination of the contents; the aforementioned output-selection unit that selects the transfer destination of the electronic mail based on selection data and rule data contained in the electronic mail; and a transmission unit that sends the electronic mail to the transfer destination that was selected by the output-selection unit.

Also, the printing apparatus related to this invention comprises: a mail-receiving unit that receives electronic mail containing selection data for specifying the output method of the contents, and contents-acquisition-destination data, which is the address of the acquisition destination of the contents; an electronic-mail-analysis unit that analyzes the contents-acquisition-destination data contained in the electronic mail received by the mail-receiving unit; a contents-receiving unit that acquires the contents corresponding to the contents-acquisition-destination data based on the contents-acquisition-destination data analyzed by electronic-mail-analysis unit; and a printing unit that prints the acquired contents.

Moreover, it is presumed that the photographic devices related this invention takes photos of an object at a plurality of resolutions, and sends the image data of the photographed object to a specified terminal. Here, it comprises a data-addition unit that adds the selection data for specifying the contents-output method that corresponds to the image data to the image data of the photographed object.

Also, it is possible to have a control-data-setting unit that sets control data for selecting the resolution from among a plurality of resolutions when photographing an object, and a mode-change unit that sets the photo resolution based on the control data set by the control-data-setting unit. When the control data contains transmission-destination data that specifies a specific terminal, the image data is sent to that specified terminal based on the transmission-destination data.

The data-control apparatus, printing apparatus, and photographic apparatus can be such that they use a computer. In that case, the units mentioned above, can be realized by executing a program by the computer.

### BRIEF DESCRIPTION OF THE DRAWINGS

FIG. 1 is a block diagram showing the interaction among the data-control apparatus, print terminal and mobile terminal of the printing system of a first embodiment of the invention.

FIG. 2A to FIG. 2C are flowcharts showing the processing procedure of the data-control apparatus of a first embodiment of the invention.

FIG. 3A to FIG. 3B are drawings showing examples of adding selection data to the image for selecting the output destination when outputting the contents.

FIG. 4 shows a first example of rule data related to the output destination.

FIG. 5 shows an example of rule data related to the output mode.

FIG. 6 shows a second example of rule data related to the output destination.

FIG. 7 is a block diagram showing the interaction among the data-control apparatus, print terminal and mobile terminal of the electronic newspaper printing system of a second embodiment of the invention.

FIG. 8 shows an example of data contained in electronic mail.

FIG. 9 is a drawing for explaining the operation of the data-generation unit and electronic-mail-transmission unit of the second embodiment of the invention.

FIG. 10 is a block diagram showing the interaction among the data-control apparatus, print terminal, mobile terminal and IP cameral of the printing system of the second embodiment of the invention.

FIG. 11 is a drawing showing the configuration of the IP camera of a third embodiment of the invention.

### DESCRIPTION OF THE PREFERRED EMBODIMENTS

For a better understanding of the invention, the preferred embodiments of the invention are explained below with reference to the supplied drawings. The embodiments described below are just examples of the invention and do not limit the technical scope of the invention.

The preferred embodiments of the invention will be described below with reference to the drawings.

(Embodiment 1)

The data-control apparatus of the embodiment can be an STB (set-top box) that is installed in the home, or a data-gateway apparatus that intermediates between the connection between a LAN (Local Area Network) in the home and an external network such as the Internet. In addition to functioning as a gateway, this data-control apparatus can also function as a media server that receives and stores contents.

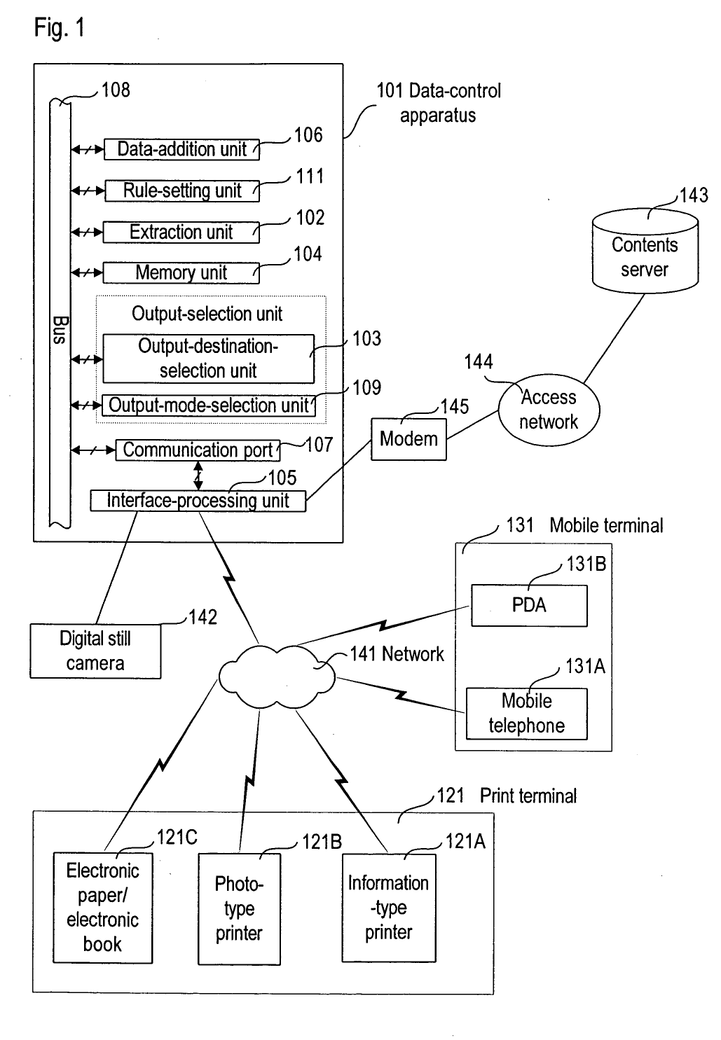

FIG. 1 is a block diagram showing the interaction among the data-control apparatus 101, print terminal 121 and mobile terminal 131 of a printing system.

The data-control apparatus 101 can connect to each unit described below via a bus 108. The processing performed by each unit will be explained in detail below.

The data-control apparatus 101 is connected to a print terminal 121 such as a information-type printer 121A, a photo-type printer 121B, or e-paper (e-book) 121C, a digital still camera 142 and a mobile terminal 131 such as a mobile phone 131A or PDA (Personal Digital Assistant) 131B via a network 141 such as a wireless network such as Bluetooth (hereafter referred to as BT) or a wireless LAN, or a wired network such as a USB (Universal Serial Bus).

Moreover, the data-control apparatus 101 is connected to a contents server 143 via an access network 144 (such as an ADSL, CATV or FTTH Internet network) and a modem 145. The contents server 143 performs the function of receiving connection requests from the data-control apparatus 101, and is constructed by servers such as an HTML server, that holds and sends newspapers, advertisements (circulars), program schedules, educational materials, magazines, photographs (images) and the like.

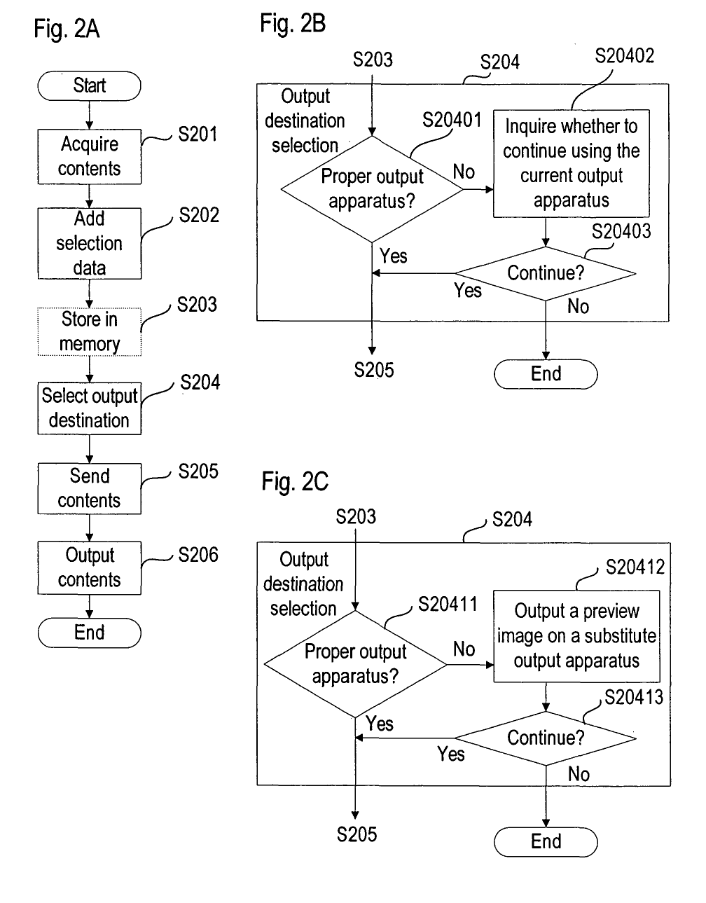

First, the data-control apparatus 101 acquires various contents that have been downloaded from the contents server 143, for example, or images that have been sent from a digital still camera 142, via an interface-processing unit 105 and communication port 107, and stores those contents temporarily in a memory unit 104 (FIG. 2A: S201).

When storing the contents, a data-addition unit 106 adds selection data, which will be used later for selecting the output destination, to the contents. The addition of selection data will be explained in detail below. The selection data is data for selecting the output apparatus of the output destination, such as a printer for example. The case of when the contents are images will be explained. In order for better understanding, resolution data will be explained before explaining the addition of selection information. Resolution is a measure for expressing the detail or smoothness of the image quality such as the display capability of a display, printing capability of a printer or scanning resolution of a scanner, and the higher (larger) that this value is, the closer the image is to being natural. When the resolution is low, unevenness called ‘jaggedness’ appears in the images or text. In the case of a display, the resolution is expressed by the number of dots displayed on the screen, and in the case of a printer or scanner, it is expressed as the number of dots per inch, and the unit ‘dpi’ (dots per inch) is used.

On the other hand, the unit for dots of color of a digital image is called a ‘pixel’. A digital image expresses one image by orderly arranging pixels vertically and horizontally in a square (or rectangular) shape.

In other words, the resolution data referred to here is the ‘number of pixels’ and ‘output size’ of the digital image, or could also be just the ‘number of pixels’. Also, it can be the resolution that is expressed in dpi that is calculated from the ‘number of pixels’ and ‘output size’.

For image data, data showing the number of pixels, resolution and size of the image are selection data. Also, the data type, such as text data, image data, or combination of image data and text data (Web page), is selection data. Furthermore, the URL of a Web page itself indicates a Web page, and since it can specify the acquisition source of the contents, it can also be used as selection data.

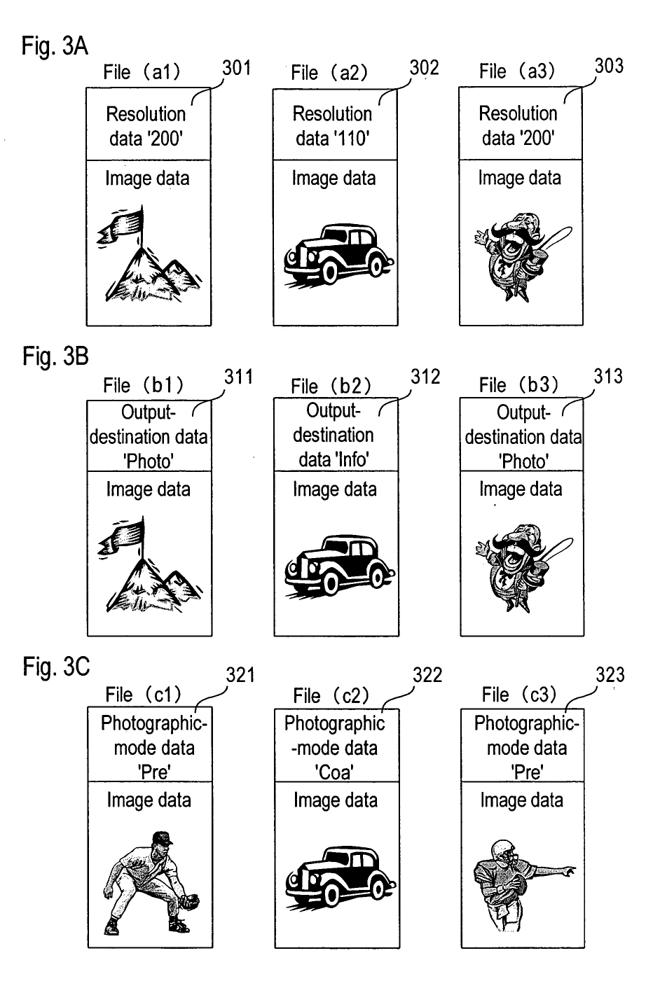

FIG. 3A to FIG. 3C are drawings showing examples of selection data that are added to the image for selecting the output destination when outputting the contents. FIG. 3A are examples of adding resolution data to the image, and the resolution data becomes the selection data. Here, the number of pixels for File (a1) is 2 Mega pixels (301), the number of pixels for File (a2) is 1.1 Mega pixels (302) and the number of pixels for File (a3) is 2 Mega pixels (303), and each is added as resolution data by the data-addition unit 106 (FIG. 2A: S202). The image (contents) to which selection data has been added is saved in the memory unit 104 (FIG. 2A: S203). The resolution data is added as internal data and is not reproduced at the same time when the image is reproduced (output). Also, there is data prepared in advance for the contents, depending on the type of contents, such as for images like those obtained from the digital still camera 142 or JPEG images that can be used as selection data. For example, the data that can be used include resolution data, output size data for the contents, output-destination data, photographic-mode data, and transmission-source data. For these kinds of images, it is not absolutely necessary to add selection data. In other words, in the case of contents that contain data that can be used instead of selection data, it is possible to use that data in the place of selection data without having to add new selection data. Of course, it is also possible to add this substitute data as selection data.

Here, when there is no data required by the output-selection unit 103 for selecting the output destination other than location data (URL etc.) of the transmission source of the contents, it is possible to use that location data to access the transmission source of the contents and acquire the necessary selection data.

That is, the terminal, which is the transmission source of the contents, or a folder in the terminal where the contents are stored, is searched. The kind of search is effective in the case when the terminal that is the transmission source is a Web server, or the like. Here, folders (terminals) in which the terms ‘photo’ or ‘scenery’ are contained in text files or the like can be determined to be photo contents.

In this way, even when it is difficult for the rule-setting unit 111 to set the output destination as described later, since the data-control apparatus acquires the necessary selection data by itself from the outside such as from the transmission source and adds it as selection data, it is possible to select the appropriate output destination for contents that do not have valid selection data.

Next, when an instruction is received from the user to output the image, for example, an extraction-unit 102 extracts the corresponding contents from the contents stored in the memory unit 104 and sends the contents to the output-destination-selection unit 103. After receiving the contents, the output-destination-selection unit 103 selects the output destination for the contents according to rules set for the contents by the rule-setting unit 111, and sends the contents to the print terminal (information-type printer 121A, photo-type printer 121B, e-paper or e-book 121C) via the communication port 107, interface-processing unit 105 and network 141. The instruction from the user can be received as a print instruction from a mobile terminal 131 via a wireless network for example. Moreover, selection of the output destination by the output-destination-selection unit 103 is performed as described below.

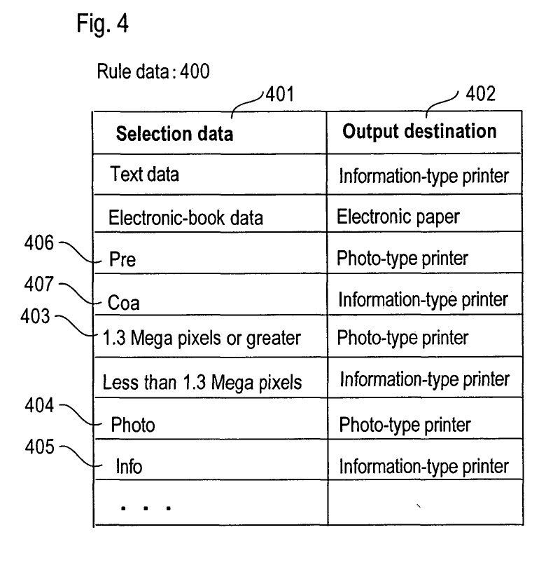

That is, the output-destination-selection unit 103 references the rule data 400 stored in the rule-setting unit 111. The rule data is saved in table format as shown in FIG. 4 for example, and stored such that it correlates the selection data 401 with the output destination 402.

Here, the output-destination-selection unit 103 reads the selection data contained in the contents, and searches for data that match the selection data from the selection data 401 in the rule data 400 to obtain the corresponding output destination 402. For example, in this example, when the selection data is 1.5 Mega pixels, the selection data 401, ‘1.3 Mega Pixels or Greater’ 403 corresponds, and the output destination becomes a photo-type printer, or in this case, photo-type printer 121B. Of course, in the case where there is a plurality of photo-type printers, each printer has an ID, product number or IP address that can be used to identify the printer, so a printer can be selected based on that data (FIG. 2A: S204).

After the output destination has been selected, the output-destination-selection unit 103 sends the contents to the selected output destination (here, the destination is the photo-type printer 121B, for example) (FIG. 2A: S205).

Each of the output-destination devices that receive the contents outputs (prints) the contents (FIG. 2A: S206).

By adding selection data as necessary and selecting the output destination according to preset rules as described above, it is possible to automatically switch the transmission destination according to the type of contents.

In the example above, the number of pixels was added as selection data, however, output-destination data could also be added as selection data. For example, as shown in FIG. 3B, ‘Photo’ (311, 313), which indicates the photo-type printer, is added to File (b1) and File (b3), and ‘Info’ (312), which indicates the information-type printer, is added to File (b2) as selection data for the contents.

As shown in FIG. 4, in this case, ‘Photo’ 404 or ‘Info’ 405 is applied as the selection data 401 for the rules.

Also, FIG. 3C shows an example of adding photographic-mode data to the selection data. Here, ‘Pre (precision)’ (321, 323), which indicate photographs in the precision mode, are added to File (c1) and File (c3), and ‘Coa (Coarse)’ (322), which indicates a photograph in the coarse mode, is added to File (c2) as the respective selection data.

As shown in FIG. 4, in this case, ‘Pre’ 406 or ‘Coa’ 407 is applied as selection data 401 for the rules.

It is also possible to add the size when outputting the contents as selection data. In this case, for example, when the size of the contents is A3, rule data is set such that the contents are output by an output apparatus (printer, etc.) that is capable of outputting A3 sized contents.

When selecting the output destination based on selection data that are added to the contents by the output-destination-selection unit 103, for example, output-destination data such as the ID, product number or IP address of the output apparatus, or in this case printer, and it is not possible to find that output apparatus, it is possible to send a notice indicating that and alternative output-destination data of alternative output apparatuses to the contents source or user who issued the instruction to output the contents and to inquire as to whether or not to continue the current output process (FIG. 2B: S20401, NO to S20402). Processing continues only when ‘Continue’ is selected in response to this inquiry (FIG. 2B: S20403, YES to S205).

In this way, even when it was not possible to find the appropriate output apparatus, it is possible to properly cope with problems of not being able to output the contents according to the transmission source of the contents, or the wishes of the users who issue the output instruction.

Also, when selecting the output destination (printer) based on selection data that is added to the contents by the output-destination-selection unit 103 and it is not possible to find the corresponding or a suitable output apparatus, it is also possible to generate and display a preview image on another output apparatus (television, etc.) (FIG. 2C: S20411, NO to S20412). Here, processing continues only when ‘Continue’ is selected on this display (FIG. 2C: S20413, YES to S205).

For example, there may be a case that when trying to print the contents using font X and the printer A is not equipped with font X, and the data-control apparatus also is not equipped with font X. In this case, normally the contents are printed using a substitute font, however, this printed image gives a different impression than when printed using the original font X. If the contents are printed as is, there is a possibility that the printed result will not satisfy the user's desire. In order to avoid this kind of problem, when the data-control apparatus is not able to find a suitable output apparatus, it outputs a temporary preview image of the output image using a substitute font to an output apparatus such as a television before outputting the contents to a substitute output apparatus.

By doing this, it is possible for the user to check the expected output using the preview image before outputting the contents to the substitute output apparatus. The display of this preview image can also be displayed on a display device connected to the data-control apparatus via a network such as a digital television, mobile terminal, personal computer or the like. By doing so, it is possible to preview the contents using the display of that device without the data-control apparatus having to have a display unit for previewing the contents, and thus it is possible to avoid the problem of outputting printed items that do not satisfy the user's desires.

An example of the output-destination-selection unit switching the output destination according to the type of contents was described above. The following is an example of switching the output mode according to the type of contents.

Most printers that are widely used today are equipped with a plurality of output modes. By setting the mode to the photo mode, for example, when printing photos, printing suitable for photos is performed. On the other hand, by setting the mode to the text mode when printing text or the like, printing is performed at high speed and printing is controlled such as to suppress the consumption of ink.

When this kind of printer is connected to a personal computer, the user changes the settings of the driver according to the type of contents. However, particularly in the case of a non-PC printer, as mentioned above, the printer is not connected to a personal computer so it is very difficult to perform detailed settings, and since the input apparatus is very simplified, it is preferred that intervention by the user, or in other words, performing detailed settings, be omitted.

Therefore, the data-control apparatus 101 comprises an output-mode-selection unit 109. The output-destination-selection unit 103 described above selected the output destination based on the contents and rule data, however, the output-mode-selection unit 109 switches the output mode based on the contents and rule data.

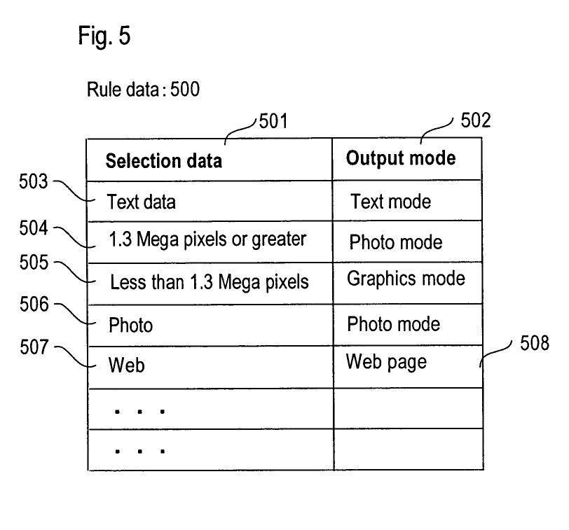

FIG. 5 shows an example of the rule data referenced by the output-mode-selection unit 109. The rule data 500 comprises selection data 501 and output mode 502. Moreover, the data-addition unit 106 adds selection data to the contents acquired from a contents server 143 indicating the type of contents. More particularly, selection data that indicates the type of contents includes text data 503, number of pixels 504, 505, photo 506, web page 507, etc. In other words, in the case that a web page (contents) is acquired from the contents server 143, for example, the data-addition unit 106 adds the selection data, ‘Web Page’, to the contents of that web page acquired from the contents server 143.

When outputting the Web page, the output-mode-selection unit 109 reads the selection data included in the Web page and references the rule data 500 to select the corresponding ‘Web Page’ mode 508.

Next, the output-mode-selection unit 109 changes the setting of the driver corresponding to the printer to which the Web page is to be output to ‘Web Page’, and sends the Web page to that printer.

By adding selection data to the contents as necessary and selecting (changing) the output mode according to a preset rule as described above, it becomes possible to automatically switch the output mode according to the type of contents. This makes it possible to minimize the intervention by the user even in the case of outputting contents to a non-PC printer. Of course, needless to say, this also makes it possible to reduce the burden on the user even when the contents are output to a normal printer that is connected to a personal computer.

In the case when it is possible to determine the type of contents from the contents format, it is not always necessary to add selection data. In the case of text data having text-file format, the output-mode-selection unit 109 should output ‘Text Mode’ as the output mode.

Next, an example of when the data-control apparatus 101 receives contents from the contents server 143 and outputs the contents to an output destination based on rules preset by the rule-setting unit will be explained.

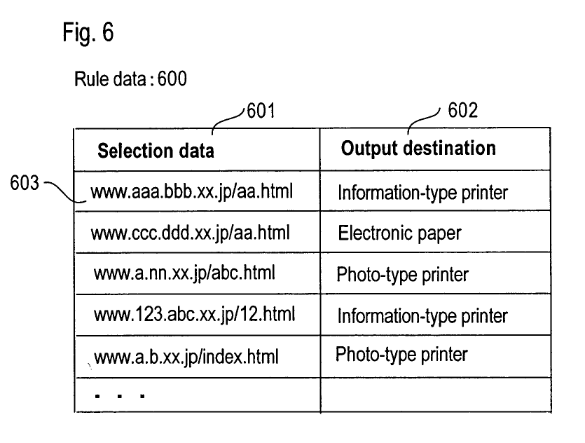

As shown in FIG. 6, in this example data 603 for identifying the contents server 143 and specific contents on the contents server 143 is stored in the selection data 601 of the rule data 600. Also, apparatus (printer) data, which is the output destination, is stored for the output destination. The data for identifying the contents can be called the contents ID, and the contents ID can be a URL or a file name.

First, the data-control apparatus 101 provides the contents ID to the contents server and sends a transmission request to transmit the contents. In response to this, the contents server 143 sends the contents, and then the data-addition unit 10 adds the contents ID, and then it is stored in the memory unit 104. However, in the case of direct output, it is not absolutely necessary for the contents to be saved in the memory unit 104.

Next, the extraction unit 102 extracts the contents stored in the memory unit 104 and sends the contents to the output-destination-selection unit 103, and the output-destination-selection unit 103 outputs the contents to the specified output apparatus based on the rule data 600. That is, in the case where the selection data, ‘www.aaa.bbb.xx.jp/aa.html’, is added to the contents, for example, the selection data is selection data 603 in FIG. 6, so the contents are automatically output to the information-type printer.

By making the selection data be data (contents ID) of the transmission source of the contents, it is possible to output the acquired contents from the proper and correct output apparatus. The contents to be output can be automatically, without intervention from the user, output from the output apparatus, and this particularly increases convenience for the user in the case of subscribing to contents such as news from a certain contents server, for example.

(Embodiment 2)

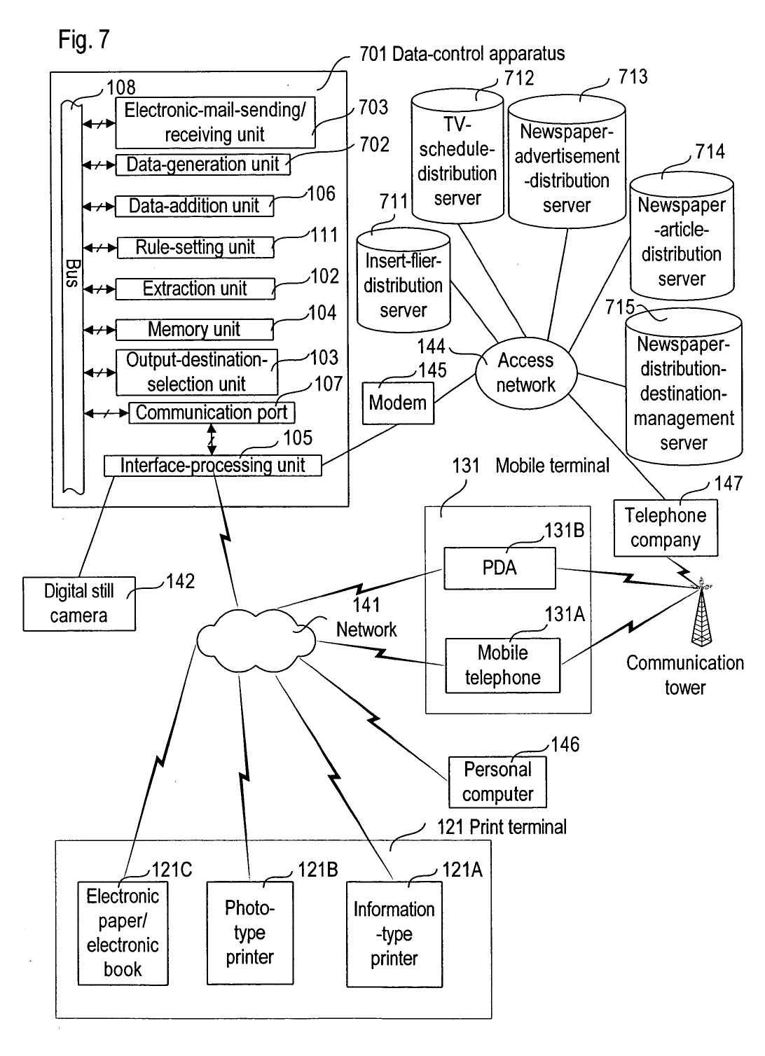

Next, FIG. 7 will be used to explain use of the data-control apparatus for distributing and printing an electronic newspaper. Explanations of parts that are identical to those of the first embodiment will be omitted.

FIG. 7 is a block diagram showing the interaction among the data-control apparatus 701, print terminal 121 and mobile terminal 131 of the printing system of this second embodiment of the invention.

A conventionally distributed newspaper contains various kinds of information such as newspaper articles, newspaper advertisements, television schedules, insert fliers, and etc. In the case of an electronic newspaper as well, in order to correspond to the various kinds of information, it is preferred that a special servers be used that correspond to the information characteristics as shown in FIG. 7.

In other words, the insert-flier server 711 is a server that distributes sales information, help wanted ads, classified ads and the like for the specified region of the newspaper subscriber. The television-schedule-distribution server 712 is a server that distributes television schedules for the television channels that can be received in the specified region of the newspaper subscriber, and since there are cases where the television channels that can be received differ for individual subscribers, it is possible to customize the schedules for each newspaper subscriber. The newspaper-ad-distribution server 713 is a server that distributes advertisements such as business advertisements that are contained in the conventional paper newspaper. The newspaper-article-distribution server 714 is a server that distributes newspaper articles. The newspaper-distribution-destination-management server 715 is a server that manages the newspaper subscribers and the destinations to which the newspaper is distributed.

First, the subscriber uses a mobile terminal 131 or personal computer 146 to make a newspaper subscription contract by performing a digital procedure on the subscription homepage, or through a visit from a newspaper salesperson. In the case of a visit from a newspaper salesperson, the information necessary for personal settings can be collected in the form of a questionnaire, and the collected information can be entered later into the newspaper-distribution-destination-management server.

Also, the subscriber can use a mobile terminal 131 or personal computer 146 to specify in advance the data-control apparatus 701 and push-print print terminal IP (Internet Protocol) address of the newspaper distribution destination. Here, it is preferred that the print terminal 121 be an information-type printer 121A that is capable of printing at somewhat high-speed, or electronic paper/electronic book 121C.

Also, it is also possible for the subscriber to be able to select a desired method from the five subscription methods given below.

The operation of the subscription methods will be explained in detail below.

First, the first method will be explained. The subscriber connects to the newspaper-distribution-destination-management server 715 from a mobile terminal 131 (mobile telephone 131A or PDA 131B) or personal computer 145, and registers the electronic-mail address of the data-control-apparatus that is installed on the subscriber side that will receive the contents (newspaper articles, newspaper ads, television schedules, insert fliers, etc.) and the distribution time (hereafter called distribution-destination data).

The distribution-destination data are saved on the newspaper-distribution-destination-management server 715 for example. The contents of each of the contents-distribution servers 711 to 714 are updated at suitable timing, for example, in the case where the contents of the newspaper-article-distribution server 714 are distributed everyday at 1:00 am, then the contents are updated at about one hour before distribution begins.

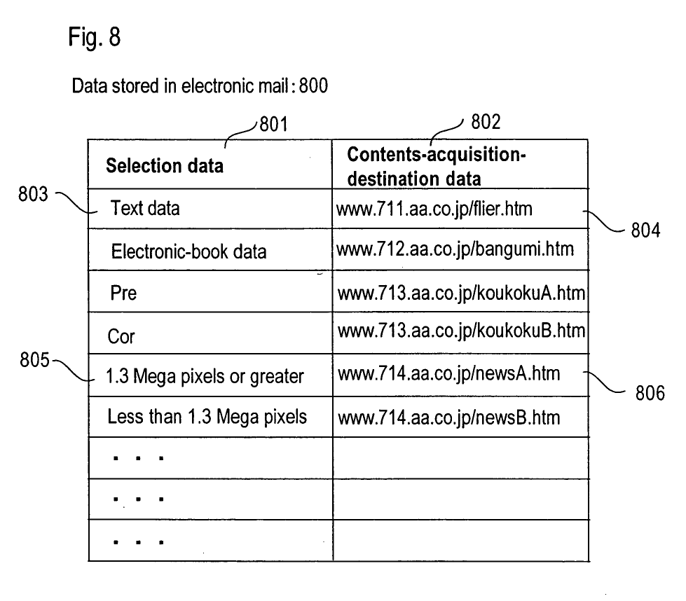

In this state, the newspaper-distribution-destination-management server 715 sends an electronic mail containing the data 800 shown in FIG. 8 to the registered electronic mail address at the distribution time. In other words, an electronic-mail-generation unit of the newspaper-distribution-destination-management server 715 pairs up the selection data 801 such as the type of contents of each of the contents-distribution servers 711 to 714 and the contents-acquisition-destination data 802, which is the addresses of the contents servers corresponding to the selection data, and stores them in the electronic mail. The selection data stored in the electronic mail is the same as the selection data described in the first embodiment above.

The contents of the data 800 will be explained in detail. A plurality of selection data is contained in the data 800, however, for an operation it will contain only one pair.

Selection data 803 of the data 800 is text data, and the corresponding contents-acquisition-destination data 804 indicates the file ‘flier.htm’ in the insert-flier-distribution server 711. This means that the file ‘flier.htm’ in the insert-flier-distribution server 711 is text data. Similarly, selection data 805 indicates an image file having 1.3 mega pixels or greater, and the corresponding contents-acquisition-destination data 806 indicates the file ‘newsA.htm’ in the newspaper-article-distribution server 714. This means that the file ‘newsA.htm’ in the newspaper-article-distribution server 714 is an image file having 1.3 mega pixels or greater.

The electronic mail containing data 800 generated by the electronic-mail-generation unit is sent to the registered electronic-mail address at the specified time. Next, the data-control apparatus 701 receives the electronic mail via an electronic-mail-sending/receiving unit 703, and the output-destination-selection unit 103 analyzes the data 800 contained in the electronic mail and determines the transfer destination for the electronic mail based on the rule data as described for the first embodiment. The rule data used here is the rule data 400 described for the first embodiment, and the IP address or electronic-mail address is stored as the output destination 402.

After the output-destination-selection unit 103 determines the transfer destination for the electronic mail, the electronic-mail-sending/receiving unit 703 sends the electronic mail to the respective print terminal 121.

Next, the print terminal 121 (here this is a photo-type printer 121B) receives the electronic mail via a mail-receiving unit, and an electronic-mail-analysis unit analyzes the data 800 contained in the electronic mail, and based on the contents-acquisition-destination data 802, the print terminal acquires the corresponding contents from the newspaper-article-distribution server 714 over a network 141 and the printing unit prints the contents.

With this kind of construction, it is possible to output the many various kinds of contents that are distributed from a plurality of distribution servers from the respective and proper output apparatus (printing apparatus). Also, since it does away with the need for each distribution server to send the contents to the respective print terminals, it is possible to lighten the burden on each respective distribution server when distributing the contents.

Next, a second method will be explained. The subscriber connects to the newspaper-distribution-destination-management server 715 from a mobile terminal 131 or personal computer 145, and registers the distribution-destination data such as the IP addresses of the data-control apparatus installed on the subscriber side that will receive the contents and the push-print print terminal 121 (information-type printer 121A or e-paper/e-book 121C) and the distribution time.

The newspaper-distribution-destination-management server 715 notifies the each of the contents-distribution servers (newspaper-article-distribution server 714, newspaper-ad-distribution server 713, television-schedule-distribution server 712, insert-flier-distribution server 711, etc.) of the registered distribution-destination data.

Each of the contents-distribution servers 711 to 715 distributes its respective contents to the distribution destination specified by the distribution-destination data at the distribution time pre-registered by the subscriber.

The data-control apparatus 701 of the subscriber receives the contents distributed by the contents-distribution servers 711 to 715, and stores them temporarily in the memory unit 104. An output destination is set for each of the contents by the rule-setting unit 111, and based on the settings of the rule-setting unit 111, the data-control apparatus 701 sequentially outputs the contents stored in the memory unit 104 to the information-type printer 121A.

The information-type printer 121A receives the print data of contents from the data-control apparatus 701 and sequentially prints the contents.

Next, a third method will be explained. In this method, after previewing the contents by a mobile terminal 131 or the like, the contents to be printed are selected and output to the print terminal 121.

The process up to distributing the contents from each of the contents-distribution servers 711 to 715 is the same as in the second method.

The data-control apparatus 701 on the subscriber side receives the contents distributed from the respective contents-distribution servers 711 to 715 and temporarily stores them in the memory unit 104.

The subscriber uses a mobile terminal 131 to preview the stored contents, then selects the contents to be output and printed, and sends and instruction to the data-control apparatus 701 to output the contents to the print terminal 121.

The data-control apparatus 701 received the print-output instruction from the mobile terminal 131 and outputs the contents to the information-type printer 121A.

The information-type printer 121A receives the print data of the contents from the data-control apparatus 701 and prints and outputs the contents.

Next, a fourth method will be explained. In this method, when storing the contents in the memory unit 104 of the data-control apparatus 701, the contents are printed and output on demand by the subscriber from the mobile terminal 131 based on the contents ID issued for each of the contents.

The process up to distributing the contents by each respective contents-distribution server 711 to 715 is the same as in the second and third methods.

The data-control apparatus 701 issues an ID for each of the contents stored in the memory unit 104, and sends the IDs by mail to the mobile terminal 131.

The subscriber sends a print instruction together with the contents ID to the data-control apparatus 701 from the mobile terminal 131.

The data-control apparatus 701 receives the contents ID and print instruction from the mobile terminal 131, and outputs the print data of the contents corresponding to the ID to the information-type printer 121A.

The information-type printer 121A receives the print data of the contents from the data-control apparatus 701 and prints and outputs the contents.

Next, a fifth method will be explained. In this method, when the contents are stored in the memory unit of the data-control apparatus 701, an ID is issued for each of the contents, and the contents with ID are output to an e-paper/e-book 121C. The subscriber then prints and outputs the contents on demand from the e-paper/e-book 121C.

The process up to distribution of the contents from each respective contents-distribution server 711 to 715 is the same as in the second, third and fourth methods.

The data-control apparatus 701 on the subscriber side receives the contents distributed from the respective contents-distribution servers 711 to 715 and stores them temporarily in the memory unit 104.

The data-control apparatus 701 issues an ID for each of the contents stored in the memory unit 104 and outputs the contents with ID to the e-paper/e-book 121C.

The subscriber sends a print instruction together with the contents ID to the data-control apparatus 701 from the e-paper/e-book 121C.

The data-control apparatus 701 receives the contents ID and print instruction from the e-paper/e-book 121C and outputs the print data of the contents corresponding to the ID to the information-type printer 121A.

The information-type printer 121A receives the print data of the contents from the data-control apparatus 701, then prints and outputs the contents.

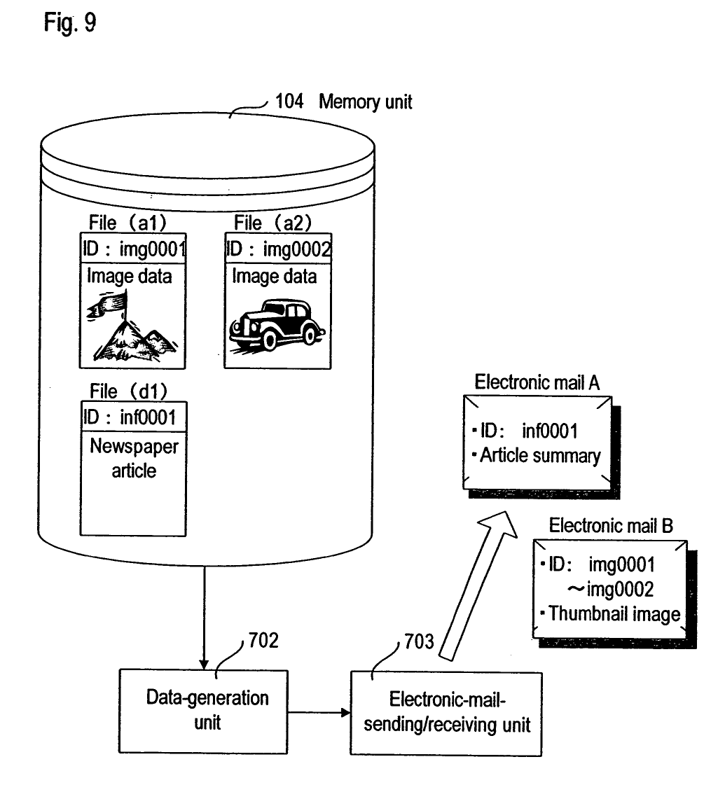

Next, FIG. 9 will be used to explain an example of the data-control apparatus 701 storing contents that were downloaded from the contents server 143 in the memory unit 104 and then generating an ID and addition data for the contents and notifying the mobile terminal 131 of the user by electronic mail.

FIG. 9 is a drawing for explaining the operation of the data-generation unit 702, which adds an ID to and stores the contents, and the electronic-mail-sending unit 703.

The data-generation unit 702 of the data-control apparatus 701 stores the contents downloaded from the contents server 143 and issues an ID for each of the contents. For the contents ID of image data, for example, it adds the ID img0001. For the contents ID of a newspaper article, it adds the ID inf0001, for example.

Moreover, when the contents is an image, the data-generation unit 702 generates a thumbnail image of the image, and when the contents is a newspaper article or the like, it generates a summary from the headline of the article.

The electronic-mail-sending unit 703 sends the contents ID and addition data that were generated by the data-generation unit 702 to the mobile terminal 131 of the user as a electronic mail A or electronic mail B, as shown in FIG. 8.

(Embodiment 3)

The data-control apparatus of a third embodiment of the invention is a data-gateway apparatus or the like that switches and outputs text or images according to the performance and resolution of the printing apparatus connected to a network similar to as in the first embodiment described above. The data-control apparatus can also be an apparatus that functions as a gateway and media server.

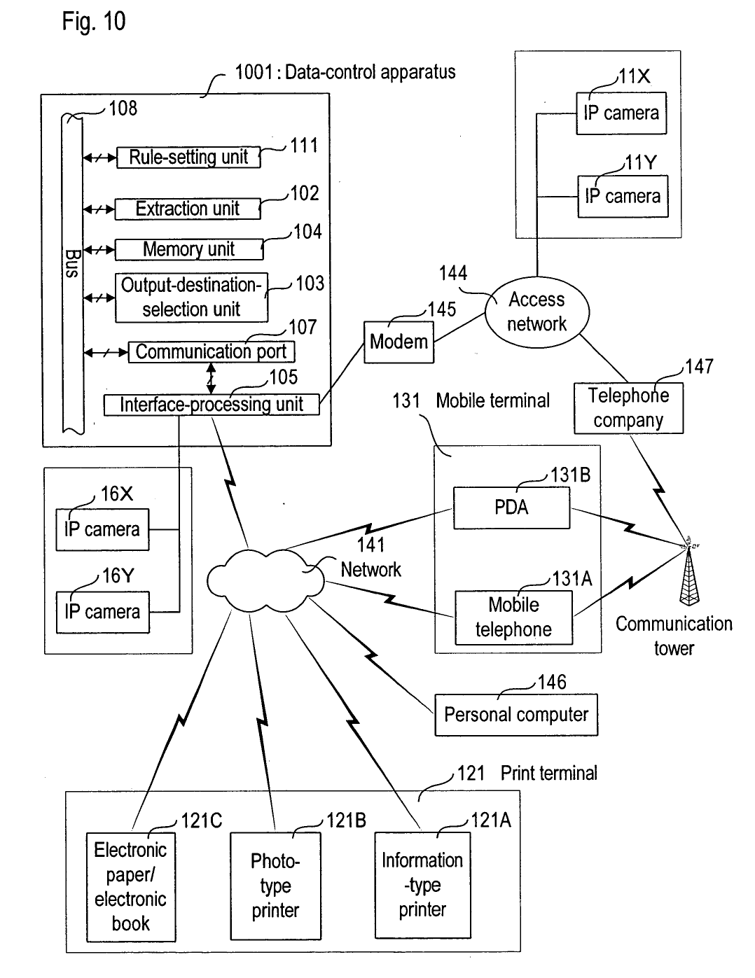

FIG. 10 is a block diagram showing the interaction among the data-control apparatus, print terminal, mobile terminal and IP camera of a broadband printing system.

Here, any redundant explanations of parts that are the same as in the first and second embodiments will be omitted, and only the interaction of the printing system with the IP (Internet Protocol) camera will be explained.

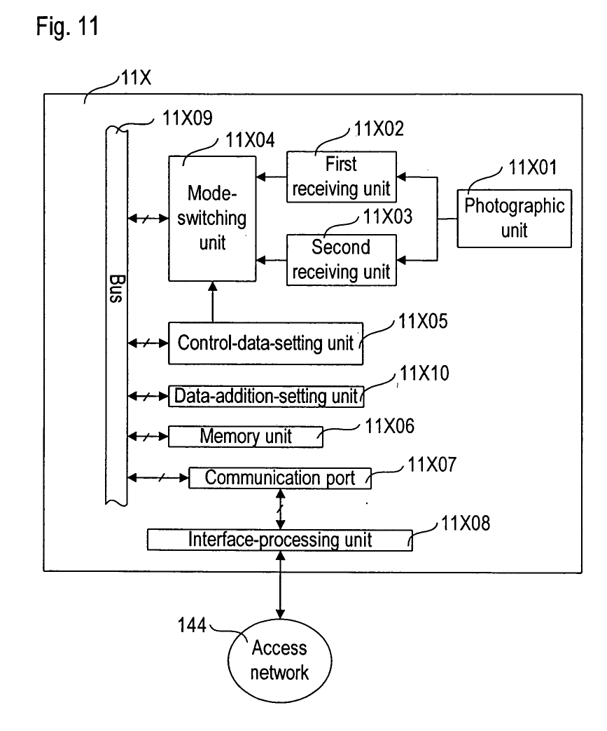

In FIG. 11 IP cameras 11X, 11Y are located at a remote location and connected to the data-control apparatus 1001 via a modem 145 and access network 144. The IP cameras 11X, 11Y have two photographic modes, precision photographic mode and coarse photographic mode, and it is possible to select the desired IP-camera image from a mobile terminal 131 or to switch the photographic mode.

The IP cameras 16X and 16Y in FIG. 10 are installed in the entranceway of the house where the data-control apparatus 1001 is installed, and connected to the data-control apparatus 1001 by a LAN (Local Area Network). The IP cameras 16X and 16Y have the same functions as IP cameras 11X and 11Y, and can be operated remotely from the mobile terminal.

First, an example of printing still images of the images captured by the remotely installed IP cameras 11X and 11Y will be explained. When the user uses the mobile terminal 131 to specify the IP address of the IP cameras 11X and 11Y to the rule-setting unit 111 of the data-control apparatus 1001, the data-control apparatus 1001 selectively receives the images captured by the IP cameras 11X and 11Y. This is made possible by the same configuration as the connection with the servers 711 to 715 in the second embodiment.

The user monitors the images of the IP cameras from the mobile terminal 131, and sets the IP address, photographic mode and printing destination of the IP camera at the desired angle in the rule-setting unit 111.

In the following explanation, it is supposed that IP camera 11X and the precision photographic mode are selected. The data-control apparatus 1001 receives the settings that were set in the rule-setting unit 111 by the user, and requests IP camera 11X to send an image (video) taken in the precision photographic mode. The IP camera 11X receives the request sent from the data-control apparatus 1001, and in the case that the current setting is the coarse photographic mode, it switches to the precision photographic mode. In the case that the current setting is the precision photographic mode, it keeps the current setting.

Next, IP camera 11X sends the captured video to the mobile terminal 131 via the data-control apparatus 1001.

The user watches the video from IP camera 11X on the mobile terminal 131 and sends a print instruction to the data-control apparatus 1001.

The data-control apparatus 1001 receives the print instruction from the mobile terminal 131 and outputs the print data for the image kept at the timing when the instruction to print the video from IP camera 11X was received to the photo-type printer 121B.

The photo-type printer 121B receives the print data for the image from the data-control apparatus 1001 and then prints and outputs the image.

Next, the case of where the photographic mode of the IP camera 11X changes at specified intervals of time will be explained.

FIG. 11 shows the construction of the IP camera 11X of this embodiment.

IP camera 11X is an IP camera that receives control data from the data-control apparatus 1001, and captures video images while switching the photographic mode at specified intervals of time. This kind of IP camera is possible by connecting the units described below via a bus 11X09.

In other words, a photographic unit 11X01 captures the image of the photographed object inside the IP camera 11X. A first image-receiving unit 11X02 detects a signal from the photographic unit 11X01 as precision-image data. A second image-receiving unit 11X03 detects a signal from the photographic unit 11X01 as coarse-image data. A mode-switching unit 11X04 switches between the image data detected by the first image-receiving unit 11X02 and the image data detected by the second image-receiving unit 11X03 based on the setting of the control-data-setting unit 11X05, and sends the image data to the memory unit 11X06 over the bus 11X09. The memory unit 11X06 stores the image data received from the mode-switching unit 11X04 via the bus 11X09. The communication port 11X07 is connected to the access network 12 via the interface-processing unit 11X08, and sends the image (video) stored in the memory unit 11X06 to the data-control apparatus 1001.

The operation in the case where the photographic mode of the IP camera 11X switches at specified intervals of time will be explained below.

The user uses the mobile terminal 131 or personal computer 146 to set control data for the IP camera 11X in the rule-setting unit 111 of the data-control apparatus 1001.

The ‘control data’ referred to here is the communication time (starting time and ending time) with the IP camera, switching interval between the precision photographic mode and the coarse photographic mode, and the interval at which to send a still image of the captured video.

The data-control apparatus 1001 transfers the control data set in the rule-setting unit 111 to the IP camera 11X.

The IP camera 11X receives the control data from the data-control apparatus 1001 and sets the communication time, mode-switching interval, and interval at which to send a still image of the captured video in the control-data-setting unit 11X05.

Next, at the time set in the control-data-setting unit 11X05 for starting communication, the IP camera 11X temporarily stores a still image of the captured video in the memory unit 11X06, after which the data-addition unit 11X10 adds selection data to the image and sends it to the data-control apparatus 1001. The selection data referred to here is the photographic mode, or in other words, the precision photographic mode, coarse photographic mode, and further the resolution and number of pixels.

In this case, the photographic-mode data is added as the photographic mode is switched by the mode-switching unit 11X04 based on the mode-switching interval set in the control-data-setting unit 11X05, and then the still image of the video stored in the memory unit 11X06 is transferred to the data-control apparatus 1001 via the communication port 11X07, interface-processing unit 11X08, access network 144 and modem 145.

The data-control apparatus 1001 receives the still image to which the photographic-mode data was added from the IP camera 11X and stores it temporarily in the memory unit 104.

Next, the extraction unit 102 sends the image stored in the memory unit 104 to the output-destination-selection unit 103, and the output-destination-selection unit 103 obtains the added photographic-mode data (selection data).

The output-destination-selection unit 103 then selects the output destination for the image based on the selection data and rule data stored in the memory unit (for example rule data 500). When the photographic-mode data indicates the precision photographic mode, ‘Pre (precision)’, the output-destination-selection unit 103 outputs the still image to the photo-type printer 121B. On the other hand, when the photographic-mode data indicates the coarse photographic mode, ‘Coa (coarse)’, the output-destination-selection unit 103 outputs the still image to the information-type printer 121A in the same way as was explained in the first embodiment.

As described above, by adding selection data for specifying the output method of the contents to the image data that was photographed by automatically switching the resolution of the image according to the date and time of the photograph, the time interval of the photograph and the photographed object, it is possible to automatically switch the output destination for the selectively photographed image data based on the selection data.

In the explanation above, the IP camera has at least two photographic modes, and controlling the switching between the modes was explained, however, it is also possible control switching between two IP cameras; one IP camera that is capable of capturing images in a precision mode and another IP camera that is capable of capturing images in a coarse mode.

Also, the photographic mode of the IP camera is not limited to the precision mode and coarse mode.

Moreover, this invention can also be applied to a combination of a plurality of photographic modes and a plurality of IP cameras.

### EFFECT OF THE INVENTION

As described above, with this invention, by adding selection data to the contents as necessary and selecting the output destination according to preset rules, it is possible to automatically switch the output destination according to the type of contents.

Also, by adding selection data to the contents as necessary and selecting (changing) the output mode according to preset rules it is possible to automatically switch the output mode according to the type of contents. This makes it possible to keep intervention by the user to a minimum particularly even in the case of output to a non-PC printer.

What is claimed is:

1. A data-control apparatus that controls the sending and receiving of contents among a plurality of devices connected over a network and comprising:
a rule-setting unit operable to store selection data for specifying the method of outputting contents and output methods corresponding to the selection data as rule data; and
an output-selection unit operable to select a method for outputting contents based on selection data read from the contents and said rule data that is stored in said rule-setting unit.

2. The data-control apparatus of claim 1 wherein said output-selection unit acquires data from the transmission source terminal of the contents that can be used as said selection data when there is no selection data in the contents that corresponds to said rule data.

3. The data-control apparatus of claim 2 further comprising a data-addition unit operable to set said selection data based on at least said contents-acquisition condition, the contents, or data obtained from said transmission source terminal, and to add that selection data to the contents.

4. The data-control apparatus of claim 1 wherein said output-selection unit displays on a specified display unit that the output method could not be selected when an output method corresponding to the selection data could not be selected.

5. The data-control apparatus of claim 4 wherein said output-selection unit further displays substitute output methods on the specified display unit.

6. The data-control apparatus of claim 1 wherein said output method is the output destination or output mode.

7. The data-control apparatus of claim 6 wherein said selection data is resolution data indicating the resolution of the contents.

8. The data-control apparatus of claim 7 wherein said resolution data contains the number of pixels.

9. The data-control apparatus of claim 6 wherein said selection data is output-destination data, which is the output destination of the contents.

10. The data-control apparatus of claim 6 wherein said selection data is photographic-mode data, which is data related to the photographic mode.

11. The data-control apparatus of claim 6 wherein said selection data is the size when outputting the contents.

12. The data-control apparatus of claim 6 wherein said selection data is transmission source data of the contents.

13. The data-control apparatus of claim 1 further comprising:
a receiving unit operable to receive electronic mail that contains said selection data and contents-acquisition-destination data, which is the address of the acquisition destination of the contents;
said output-selection unit operable to select the transfer destination of said electronic mail based on selection data, which is contained in said electronic mail, and said rule data; and
a sending unit operable to send said electronic mail to the transfer destination that is selected by said output-selection unit.

14. A control method of controlling the receiving and sending of contents among a plurality of devices connected over a network and comprising:
a rule-setting step of storing selection data for specifying the method of outputting contents and output methods corresponding to the selection data as rule data; and
an output-selection step of selecting a method for outputting contents based on selection data read from the contents and said rule data that is stored in said rule-setting step.

15. A program that is executed by a computer and controls the receiving and sending of contents among a plurality of devices connected over a network and comprising:
a rule-setting step of storing selection data for specifying the method of outputting contents and output methods corresponding to the selection data as rule data; and
an output-selection step of selecting a method for outputting contents based on selection data read from the contents and said rule data that is stored in said rule-setting step.

16. A program that is executed by a computer and controls the receiving and sending of contents among a plurality of devices connected over a network and comprising:
a rule-setting step of storing selection data for specifying the method of outputting contents and output methods corresponding to the selection data as a rule data;
a receiving step of receiving electronic mail containing said selection data and contents-acquisition-destination data, which is the address of the acquisition destination of the contents;
an output-selection step of selecting the transfer destination of said electronic mail based on selection data, which is contained in said electronic mail, and said rule data, which was stored in said rule-setting step; and
a sending step of sending said electronic mail to the transfer destination that is selected in said output-selection step.

17. A printing apparatus comprising:
a mail-receiving unit operable to receive electronic mail containing selection data for specifying a method of outputting contents, and contents-acquisition-destination data, which is the address of the acquisition destination of the contents;
an electronic-mail-analysis unit operable to analyze the contents-acquisition-destination data contained in the electronic mail received by said mail-receiving unit;
a contents-receiving unit operable to acquire contents corresponding to the contents-acquisition-destination data based on the contents-acquisition-destination data analyzed by said electronic-mail-analysis unit; and
a printing unit operable to print said acquired contents.

18. The printing apparatus of claim 17 wherein said contents-acquisition-destination data is the URL (Uniform Resource Locator) of the transmission source of the contents.

19. The printing apparatus of claim 18 wherein
said contents-receiving unit receives the contents of each level of a URL in the case that the URL comprises levels; and wherein
said printing unit receives the contents of each of said levels.

20. A program executed by a computer and comprising:
a mail-receiving step of receiving electronic mail containing selection data for specifying the method of outputting contents, and contents-acquisition-destination data, which is the address of the acquisition destination of the contents;
an electronic-mail-analysis step of analyzing the contents-acquisition-destination data contained in the electronic mail received in said mail-receiving step;
a contents-receiving step of acquiring contents that correspond to said contents-acquisition-destination data based on the contents-acquisition-destination data analyzed in said electronic-mail-analysis step; and
a printing step of printing said acquired contents.

21. A printing system comprising; a data-control apparatus that controls sending and receiving of contents amount a plurality of devices connected over a network; and a plurality of printing apparatuses and wherein
said data-control apparatus comprises:
a rule-setting unit operable to store selection data for specifying a method of outputting contents and output methods corresponding to the selection data as rule data;
a receiving unit operable to receive electronic mail containing said selection data and contents-acquisition-destination data, which is the address of the acquisition destination of the contents;
an output-selection unit operable to select the transfer destination for said electronic mail based on said selection data, which is contained in said electronic mail, and said rule data; and
a sending unit operable to send said electronic mail to the transfer destination selected by said output-selection unit; and wherein
said printing apparatuses comprise:
a mail-receiving unit operable to receive said electronic mail from said data-control apparatus;
an electronic-mail-analysis unit operable to analyze the contents-acquisition-destination data contained in the electronic mail received by said mail-receiving unit;
a contents-receiving unit operable to acquire contents corresponding to the contents-acquisition-destination data based on the contents-acquisition-destination data analyzed by said electronic-mail-analysis unit; and
a printing unit operable to print said acquired contents.

22. The printing system of claim 21, wherein said sending apparatus corresponding to said contents-acquisition-destination data further comprises:
an electronic-mail-generation unit operable to generate electronic mail containing said selection data and said contents-acquisition-destination data; and
a sending unit operable to send the electronic mail generated by said electronic-mail-generation unit to said data-control apparatus.

23. A printing method of printing the contents from a plurality of devices connected over a network and comprising:
a receiving step of receiving electronic mail containing selection data for specifying a method of outputting contents and contents-acquisition-destination data, which is the address of the acquisition destination of the contents;
an output-selection step of selecting the transfer destination of said electronic mail based on said selection data contained in said electronic mail, and rule data, which relates the selection data to an output method corresponding to that selection data;
a sending step of sending said electronic mail to the transfer destination selected in said output-selection step;
a mail-receiving step of receiving said electronic mail;
an electronic-mail-analysis step of analyzing contents-acquisition-destination data contained in the electronic mail received by said mail-receiving step;
a contents-receiving step of acquiring the contents corresponding to the contents-acquisition-destination data based on the contents-acquisition-destination data analyzed in said electronic-mail-analysis step; and
a printing step of printing said acquired contents.

24. A photographic apparatus that photographs an object with a plurality of resolutions and sends the photographed image data to a specific terminal and comprising:
a data-addition unit operable to add selection data to the photographed image data for specifying a method of outputting contents that correspond to the image data.

25. The photographic apparatus of claim 24 further comprising:
a control-data-setting unit operable to set control information for selecting a resolution from among said plurality of resolutions when photographing an object; and
a mode-switching unit operable to set said resolution based on control data set by said control-data-setting unit.

26. The photographic apparatus of claim 25 wherein said control data contains sending-destination data that specifies said specific terminal and said image data is sent to said specific terminal based on that sending-destination data.

27. A program executed by a computer for photographing an object with a plurality of resolutions and sending the photographed image data to a specific terminal and comprising:
a data-addition step of adding selection data, which is for specifying a method of outputting contents that corresponds to the image data, to the photographed imaged data; and
a sending step of sending image data, to which said selection data is added, to said specific terminal.

28. A printing system of printing image data, which is photographed by a photographic apparatus that photographs an object with a plurality of resolutions, by a specified printing apparatus via a network wherein
said photographic apparatus comprises:
a data-addition unit operable to add selection data to the photographed imaged data for specifying a method of outputting contents that correspond to the image data; and
a sending unit that is operable to sending the image data, to which said selection data is added, to a data-control apparatus that controls sending and receiving of contents; and wherein
said data-control apparatus comprises:
a rule-setting unit operable to store selection data for specifying a method of outputting contents and output methods corresponding to the selection data as rule data; and
an output-selection unit operable to select a printing apparatus, which will be the output destination of the image data, based on said selection data read from said image data, and rule data stored by said rule-setting unit, and to send the image data to the printing apparatus.

29. A printing method that photographs an object with a plurality of resolutions and prints the photographed image data by a specific printing apparatus via a network and comprising:
a data-addition step of adding selection data, which is for specifying a method of outputting the image data that corresponds to the image data, to the photographed image data; and
an output-selection step of selecting the printing apparatus, which will be the output destination for said image data, based on selection data read from said image data, and rule data that relates the selection data for specifying the output method for the image data to the output destination corresponding to that selection data, and sending the image data to said printing apparatus.
